(19) United States
(12) Patent Application Publication
(10) Pub. No.: US 2025/0365782 A1
(43) Pub. Date: Nov. 27, 2025

(54) MULTI-DEVICE SYSTEM, WIRELESS CONNECTION METHOD AND NON-TRANSITORY COMPUTER READABLE STORAGE MEDIUM

(71) Applicant: HTC Corporation, Taoyuan City (TW)

(72) Inventors: Kai-Hsiu CHEN, Taoyuan City (TW); Hung-Ching YEH, Taoyuan City (TW)

(21) Appl. No.: 18/674,911

(22) Filed: May 26, 2024

(51) Int. Cl. H04W 76/10; H04W 48/16

(52) U.S. Cl. CPC H04W 76/10; H04W 48/16

(57) ABSTRACT

The present disclosure provides a wireless connection method applicable to a multi-device system. The multi-device system includes a first electronic device and a second electronic device. The wireless connection method includes: by the first electronic device, determining if a network access device is available for a single-band communication or a multi-band communication; by the first electronic device, establishing a first wireless connection in a first frequency band with the network access device; and when the network access device is available for the multi-band communication, by the second electronic device, establishing a second wireless connection in a second frequency band with the network access device, wherein the first frequency band is larger than the second frequency band in a transmission bandwidth.

### BACKGROUND

### Field of Invention

This disclosure relates to a system and method, in particular to a multi-device system and wireless connection method.

### Description of Related Art

In some applications of Wi-Fi connection, a host device may transmit data with two devices in the same frequency band through a Wi-Fi access point (AP). However, due to a contention-based protocol, the host device cannot perform a data transmission with one of the two devices until another data transmission with the other one of the two devices is completed, which cause a limitation on the transmission throughput among the host device and the two devices. Therefore, it is necessary to provide an approach to address the above issue caused due to the contention-based protocol.

### SUMMARY

An aspect of present disclosure relates to a wireless connection method applicable to a multi-device system. The multi-device system includes a first electronic device and a second electronic device. The wireless connection method includes: by the first electronic device, determining if a network access device is available for a single-band communication or a multi-band communication; by the first electronic device, establishing a first wireless connection in a first frequency band with the network access device; and when the network access device is available for the multi-band communication, by the second electronic device, establishing a second wireless connection in a second frequency band with the network access device, wherein the first frequency band is larger than the second frequency band in a transmission bandwidth.

Another aspect of present disclosure relates to a multi-device system. The multi-device system includes a first electronic device and a second electronic device. The first electronic device is configured to determine if a network access device is available for a single-band communication or a multi-band communication, and is configured to establish a first wireless connection in a first frequency band with the network access device. The second electronic device is configured to establish a second wireless connection in a second frequency band with the network access device when the network access device is available for the multi-band communication. The first frequency band is larger than the second frequency band in a transmission bandwidth.

Another aspect of present disclosure relates to a non-transitory computer readable storage medium with a computer program to execute a wireless connection method applicable to a multi-device system. The multi-device system includes a first electronic device and a second electronic device. The wireless connection method includes: by the first electronic device, determining if a network access device is available for a single-band communication or a multi-band communication; by the first electronic device, establishing a first wireless connection in a first frequency band with the network access device; and when the network access device is available for the multi-band communication, by the second electronic device, establishing a second wireless connection in a second frequency band with the network access device, wherein the first frequency band is larger than the second frequency band in a transmission bandwidth.

It is to be understood that both the foregoing general description and the following detailed description are by examples, and are intended to provide further explanation of the invention as claimed.

### BRIEF DESCRIPTION OF THE DRAWINGS

The present disclosure can be more fully understood by reading the following detailed description of the embodiment, with reference made to the accompanying drawings as follows:

FIG. 1 is a schematic diagram of a multi-device system in accordance with some embodiments of the present disclosure;

FIG. 2 is a flow diagram of a wireless connection method in accordance with some embodiments of the present disclosure;

FIG. 3 is a flow diagram of an operation of the wireless connection method in accordance with some embodiments of the present disclosure;

FIG. 4 is a schematic diagram of a scenario of the multi-device system in accordance with some embodiments of the present disclosure;

FIG. 5 is a schematic diagram of a scenario of the multi-device system in accordance with some embodiments of the present disclosure; and

FIG. 6 is a schematic diagram of a scenario of the multi-device system in accordance with some embodiments of the present disclosure.

### DETAILED DESCRIPTION

The embodiments are described in detail below with reference to the appended drawings to better understand the aspects of the present application. However, the provided embodiments are not intended to limit the scope of the disclosure, and the description of the structural operation is not intended to limit the order in which they are performed. Any device that has been recombined by components and produces an equivalent function is within the scope covered by the disclosure.

As used herein, “coupled” and “connected” may be used to indicate that two or more elements physical or electrical contact with each other directly or indirectly, and may also be used to indicate that two or more elements cooperate or interact with each other.

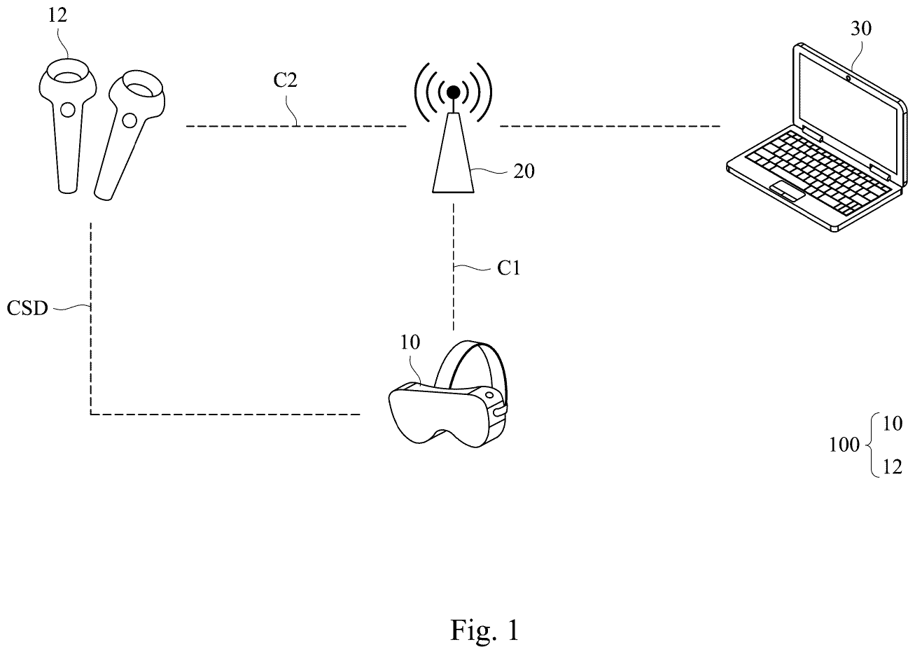

Referring to FIG. 1, FIG. 1 is a schematic diagram of a multi-device system 100 in accordance with some embodiments of the present disclosure. In some embodiments, the multi-device system 100 includes a first electronic device 10 and a second electronic device 12. The first electronic device 10, the second electronic device 12 and a computer device 30 can all be moved into a service area of a network access device 20. Thus, as shown in FIG. 1, the first electronic device 10, the second electronic device 12 and the computer device 30 can all connect with the network access device 20 to receive a network service through the network access device 20. Notably, the first electronic device 10 can communicate with the second electronic device 12 and the computer device 30 in different frequency bands where the network access device 20 is operable, respectively, through the network service provided by the network access device 20. In such arrangements, the limitation on the transmission throughput among the first electronic device 10, the second electronic device 12 and the computer device 30 due to the contention-based protocol can be alleviated.

In some embodiments, the network access device 20 can be implemented by a Wi-Fi access point (AP), to operate in a Wi-Fi AP mode. In the Wi-Fi AP mode, the network access device 20 can broadcast in at least one frequency band. In particular, the network access device 20 is available for a single-band communication when being capable of broadcasting in only one frequency band (e.g., in 2.4 GHZ, 5 GHZ or 6 GHZ), and is available for a multi-band communication when being capable of broadcasting in more than one frequency band (e.g., in 2.4 GHZ, 5 GHZ and 6 GHZ). The first electronic device 10, the second electronic device 12 and the computer device 30 can all operate in a Wi-Fi station (STA) mode to wirelessly connect with the network access device 20 operating in the Wi-Fi AP mode.

In some embodiments, the first electronic device 10 and the second electronic device 12 each includes at least a processor, a camera, storage, a short distance communication circuit and a long distance communication circuit. The processor can be coupled to the camera, the storage, the long distance communication circuit and the short distance communication circuit. In particular, the processor can be implemented by a central processing unit (CPU), an application-specific integrated circuit (ASIC), a microprocessor, a system on a Chip (SoC) or other suitable processing circuits. The storage can be implemented by a volatile memory, a non-volatile memory, or the both. The short distance communication circuit can support a Bluetooth Low Energy (BLE) protocol, a Bluetooth protocol or other short distance communication protocols. The long distance communication circuit can support a Wi-Fi protocol or other long distance communication protocols.

In accordance with the above embodiments, the network access device 20 and the computer device 30 each also includes a communication circuit supporting the Wi-Fi protocol or other long distance communication protocols. Thus, as shown in FIG. 1, when the first electronic device 10 is in the service area of the network access device 20, a first wireless connection C1 can be established between the first electronic device 10 and the network access device 20 under one of the long distance communication protocols (e.g., the Wi-Fi protocol). When the second electronic device 12 is in the service area of the network access device 20, a second wireless connection C2 can be established between the second electronic device 12 and the network access device 20 under one of the long distance communication protocols (e.g., the Wi-Fi protocol). Also, when the computer device 30 is in the service area of the network access device 20, another wireless communication can be established between the computer device 30 and the network access device 20 under one of the long distance communication protocols (e.g., the Wi-Fi protocol).

In some practical applications, the first electronic device 10 and the second electronic device 12 can be operated together as a display system. This display system is used to provide an immersive content (e.g., a virtual reality (VR) environment, an augmented reality (AR) environment, a mixed reality (MR) environment, etc.) for a user. As shown in FIG. 1, the first electronic device 10 can be a head-mounted device (HMD) regarded as a host of the display system, in which the user can wear the HMD on the head to perceive the immersive content. The second electronic device 12 can be controllers regarded as an accessory of the display system, in which the user can use the controllers to control at least one virtual reality object in the immersive content. It should be understood that the second electronic device 12 is not limited to be the controllers or other accessories. For example, the second electronic device 12 can be an entertainment device (e.g., gamepad) or a mobile device (e.g., tablet, smartphone, etc.). Also, the number of the second electronic device 12 is not limited to 1 (as shown in FIG. 1), and can be more than 1.

The communication between the first electronic device 10 and the computer device 30 through the first wireless connection C1 is described herein. In one example, the first electronic device 10 can transmit image data related to the immersive content to the computer device 30 so as to share the immersive content through the computer device 30. In another example, the first electronic device 10 can receive the image data related to the immersive content, which are generated by the computer device 30, from the computer device 30 so as to provide the immersive content for the user. That is to say, the computer device 30 can be operated as a software server of the display system.

The communication between the first electronic device 10 and the second electronic device 12 through the first wireless connection C1 and the second wireless connection C2 is described herein. In one example, the second electronic device 12 can receive map data related to a physical environment where the multi-device system 100 is from the first electronic device 10. Then, the second electronic device 12 can calculate its pose data according to the map data by some visual-based localization technologies (e.g., simultaneous localization and mapping (SLAM)), so as to transmit the pose data back to the first electronic device 10. In another example, the second electronic device 12 generates its pose data by an inertial measurement unit (e.g., an accelerometer, a gyroscope and a magnetometer, etc.), so as to transmit the pose data to the first electronic device 10. In yet another example, the first electronic device 10 can transmit command data to the second electronic device 12, so as to control the second electronic device 12 to operate in an idle mode, a standby mode, or other operation modes.

In some embodiments, the first electronic device 10 and the second electronic device 12 can communicate with each other without the first wireless connection C1 and the second wireless connection C2 (i.e., without the network service provided by the network access device 20). When the first electronic device 10 is near the second electronic device 12, as shown in FIG. 1, a short distance wireless connection CSD can be established between the first electronic device 10 and the second electronic device 12 under one of the short distance communication protocols (e.g., the BLE protocol). The short distance wireless connection CSD can be used to transmit data which are smaller than the image data, the map data, the pose data and/or the command data in the data size.

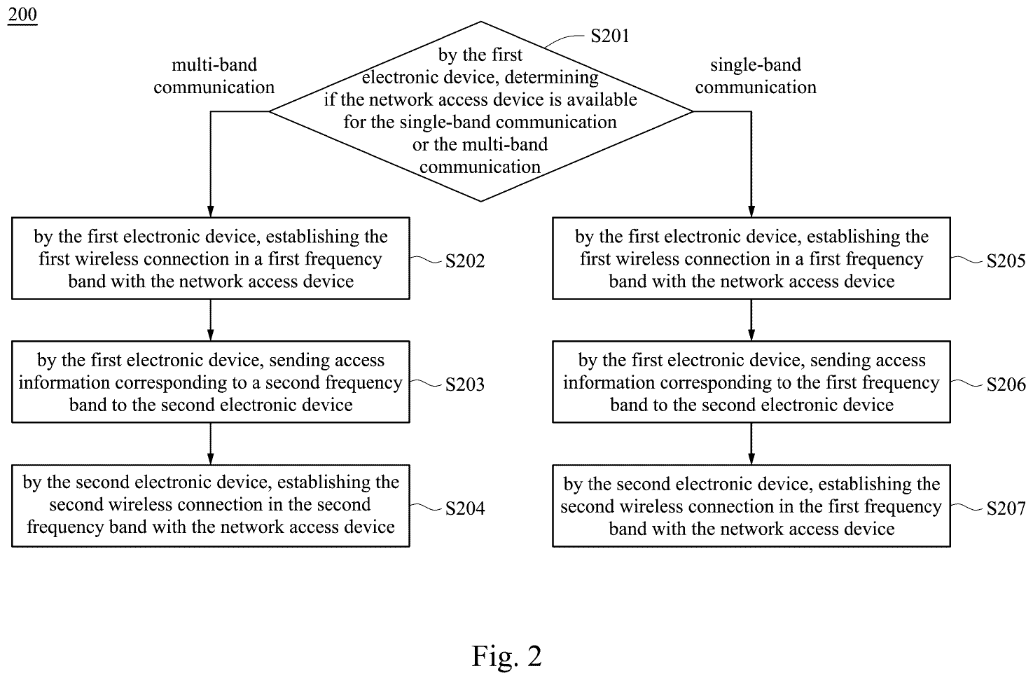

The operation of the multi-device system 100 of FIG. 1 would be further described with reference to a wireless connection method 200 applicable to the multi-device system 100. Referring to FIG. 2, FIG. 2 is a flow diagram of the wireless connection method 200 in accordance with some embodiments of the present disclosure. In some embodiments, as shown in FIG. 2, the wireless connection method 200 includes operations S201-S207.

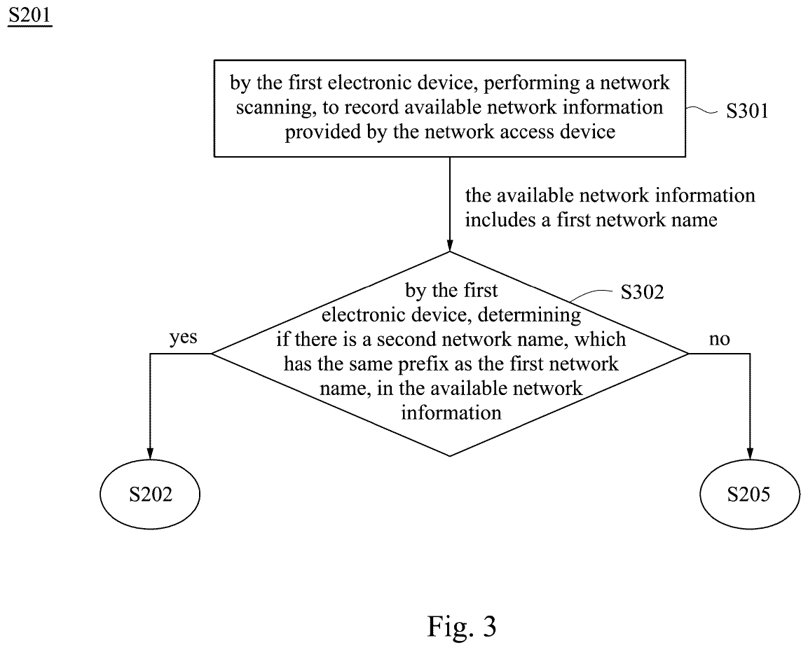

In operation S201, the first electronic device 10 determines if the network access device 20 is available for the single-band communication or the multi-band communication, which would be described in detail with reference to FIG. 3. FIG. 3 is a flow diagram of operation S201 of the wireless connection method 200 in accordance with some embodiments of the present disclosure. In some embodiments, as shown in FIG. 3, operation S201 includes sub-operations S301 and S302.

In sub-operation S301, the first electronic device 10 performs a network scanning, to record available network information INL provided by the network access device 20. In some embodiment, when performing the network scanning in proximity to the network access device 20, the first electronic device 10 receives at least one beacon signal (not shown) outputted periodically by the network access device 20. Each beacon signal is used to inform devices which require the network service (e.g., the first electronic device 10) about a particular wireless network. For example, each beacon signal can indicate at least a name and channel information of the particular wireless network. Accordingly, by receiving the at least one beacon signal outputted by the network access device 20, the first electronic device 10 can list at least one wireless network as the available network information INL. It should be understood that the network scanning can be a Wi-Fi scanning, and the network name is known as a Service Set Identifier (SSID).

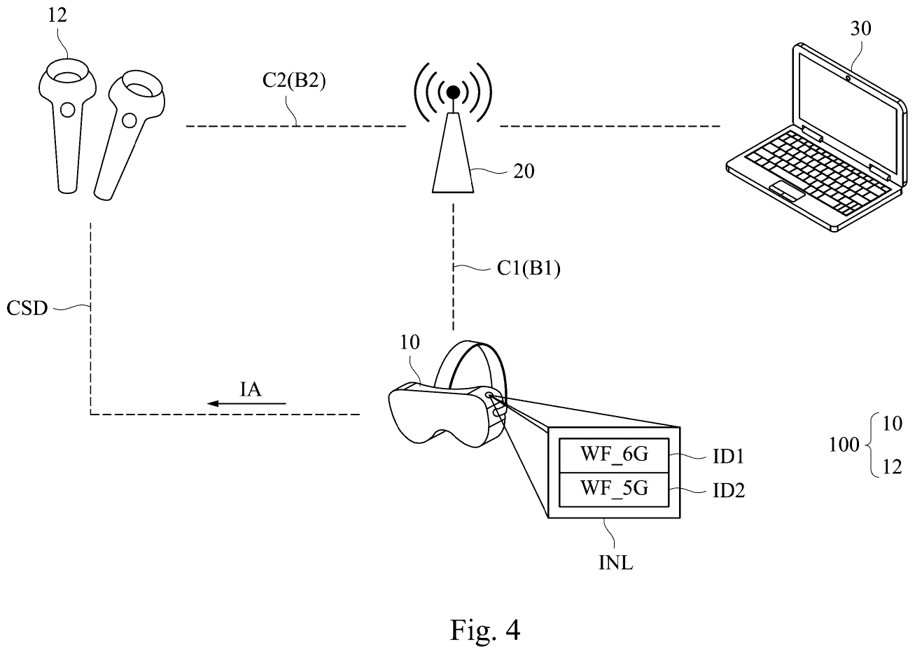

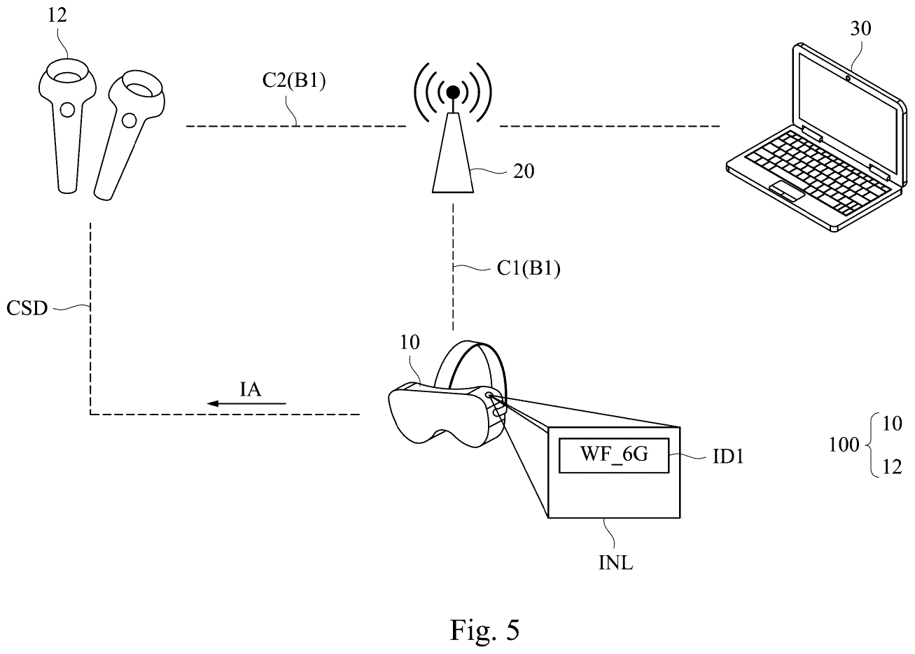

Referring to FIGS. 4 and 5, FIGS. 4 and 5 are schematic diagrams of two scenarios of the multi-device system 100 in accordance with some embodiments of the present disclosure. In some embodiments, as shown in FIGS. 4 and 5, the available network information INL includes a first network name ID1. In particular, the first network name ID1 is indicated by a first beacon signal broadcasted by the network access device 20.

Generally, if the network access device 20 is available for the multi-band communication, there may be at least two similar network names in the available network information INL. Thus, as shown in FIG. 3, sub-operation S302 is executed. In sub-operation S302, the first electronic device 10 determines if there is a second network name ID2, which has the same prefix as the first network name ID1, in the available network information INL. It should be understood that a number of characters of the prefix can be preset.

In some embodiments, as shown in FIG. 4, a first prefix of the first network name ID1 is “WF”. Also, the available network information INL further includes the second network name ID2. Notably, a second prefix of the second network name ID2 is also “WF”, which means a second beacon signal indicating the second network name ID2 may also be broadcasted by the network access device 20. Thus, in some embodiments of sub-operation S302, the first electronic device 10 determines that there is the second network name ID2 having the same prefix as the first network name ID1 in the available network information INL. In this case, the network access device 20 is available for the multi-band communication, and operations S202-S204 are executed as shown in FIG. 2.

In some embodiments, as shown in FIG. 5, the available network information INL includes the first network name ID1, whose prefix is “WF”, but without the second network name ID2 as shown in FIG. 4. Thus, in some embodiments of sub-operation S302, the first electronic device 10 determines that there is no the second network name ID2 having the same prefix as the first network name ID1 in the available network information INL. In this case, the network access device 20 is available for the single-band communication, and operations S205-S207 are executed as shown in FIG. 2.

In operation S202, the first electronic device 10 establishes the first wireless connection C1 in a first frequency band B1 with the network access device 20. In the embodiments of FIG. 4, the first beacon signal indicating the first network name ID1 may be broadcasted over at least one channel in the first frequency band B1 (e.g., 6 GHZ). That is to say, the first network name ID1 is corresponding to the first frequency band B1. The first electronic device 10 can send a first network access request, which carries first authentication information (e.g., a first access password) corresponding to the first network name ID1, to the network access device 20. The first authentication information may be pre-stored in the storage of the first electronic device 10 or be inputted by the user into the first electronic device 10. The network access device 20 can check the first authentication information carried by the first network access request against first preset information (e.g., a first preset password) corresponding to the first network name ID1, to determine if the first electronic device 10 is able to access a first wireless network corresponding to the first network name ID1. Then, when the network access device 20 confirms the first electronic device 10 can access the first wireless network corresponding to the first network name ID1, as shown in FIG. 4, the first wireless connection C1 is established in the first frequency band B1 corresponding to the first network name ID1.

In operation S203, the first electronic device 10 sends access information IA corresponding to a second frequency band B2 to the second electronic device 12. In the embodiments of FIG. 4, the second beacon signal indicating the second network name ID2 may be broadcasted over at least one channel in the second frequency band B2 (e.g., 5 GHZ). That is to say, the second network name ID2 is corresponding to the second frequency band B2. The first electronic device 10 uses at least the second network name ID2 and second authentication information (e.g., a second access password) as the access information IA, and transmits the access information IA through the short distance wireless connection CSD. In particular, the second authentication information can be the same as the first authentication information (that is, the second access password can be the same as the first access password), but the present disclosure is not limited herein.

In operation S204, the second electronic device 12 establishes the second wireless connection C2 in the second frequency band B2 with the network access device 20. The second electronic device 12 can send a second network access request to the network access device 20 according to the access information IA. For example, the second network access request may carry the second authentication information corresponding to the second network name ID2. The network access device 20 can check the second authentication information carried by the second network access request against second preset information corresponding to the second network name ID2, to determine if the second electronic device 12 is able to access a second wireless network corresponding to the second network name ID2. Then, when the network access device 20 confirms the second electronic device 12 can access the second wireless network corresponding to the second network name ID2, as shown in FIG. 4, the second wireless connection C2 is established in the second frequency band B2 corresponding to the second network name ID2.

It can be seen from the descriptions of operations S202-S204 that the first wireless connection C1 and the second wireless connection C2 are similar in network name. In particular, the first network name ID1 can be regarded as the network name of the first wireless connection C1, and the second network name ID2, which has the same prefix as the first network name ID1, can be regarded as the network name of the second wireless connection C2.

In some further embodiments of operations S202-S204, when the available network information INL includes the first network name ID1 and the second network name ID2, the first electronic device 10 finds which of the first network name ID1 and the second network name ID2 corresponding to a larger transmission bandwidth. In the embodiments of FIG. 4, the first electronic device 10 finds that the first frequency band B1 (i.e., 6 GHZ) is larger than the second frequency band B2 (i.e., 5 GHZ) in the transmission bandwidth, that is, the first network name ID1 is corresponding to the larger transmission bandwidth. Thus, the first wireless connection C1 between the first electronic device 10 and the network access device 20 is established in the first frequency band B1 corresponding to the larger transmission bandwidth, which is because the first electronic device 10 as the host of the display system usually requires to transmit mass data with multiple devices (e.g., the second electronic device 12 and the computer device 30). Also, because the second electronic device 12 as the accessary of the display system usually communicates with the first electronic device 10 only and thus does not require to transmit mass data, the second wireless connection C2 between the second electronic device 12 and the network access device 20 is established in the second frequency band B2 corresponding to a smaller transmission bandwidth.

In addition, based on the above arrangements, a first data transmission between the first electronic device 10 and the second electronic device 12 and a second data transmission between the first electronic device 10 and the computer device 30 can occur at the same time without being in contention for the same frequency band.

Backing the case that the network access device 20 is available for the single-band communication (i.e., the embodiments of FIG. 5), in operation S205, the first electronic device 10 establishes the first wireless connection C1 in a first frequency band B1 with the network access device 20. The descriptions of operation S205 are similar to those of operation S202, and therefore are omitted herein.

In operation S206, the first electronic device 10 sends access information IA corresponding to the first frequency band B1 to the second electronic device 12. In the embodiments of FIG. 5, the first electronic device 10 uses at least the first network name ID1 and the first authentication information as the access information IA.

In operation S207, the second electronic device 12 establishes the second wireless connection C2 in the first frequency band B1 with the network access device 20. The second electronic device 12 can request permission to access the first wireless network corresponding to the first network name ID1 from the network access device 20 according to the access information IA. Accordingly, as shown in FIG. 5, the second wireless connection C2 is established in the first frequency band B1 corresponding to the first network name ID1.

In some further embodiments of FIG. 5, the first electronic device 10 may receive the second beacon signal indicating the second network name ID2 after listing the first network name ID1 in the available network information INL. In this case, the first electronic device 10 determines if the second network name ID2 has the same prefix as the first network name ID1. When the second network name ID2 has the same prefix as the first network name ID1, the first electronic device 10 selects the second network name ID2 to generate the access information IA which is used to be provided to the second electronic device 12. The descriptions of selecting the second network name ID2 to generate the access information IA are similar to those of operation S203, and therefore are omitted herein.

It should be understood that another network access device is possibly set to broadcast a name of another wireless network having the same prefix as the first network name ID1. Thus, the first electronic device 10 has to further check whether the second beacon signal indicating the second network name ID2 is outputted by the network access device 20 which outputs the first beacon signal indicating the first network name ID1. In some further embodiments, when the second network name ID2 has the same prefix as the first network name ID1, the first electronic device 10 calculates both a first signal strength value of the first beacon signal and a second signal strength value of the second beacon signal. The first signal strength value and the second signal strength value can be calculated in the same manner as calculating received signal strength indication (RSSI). The first electronic device 10 then determines if the second signal strength value is the closest to the first signal strength value (or if a difference between the second signal strength value and the first signal strength value is smaller than a preset threshold). Generally, if both the second beacon signal and the first beacon signal are outputted by the same network access device 20, the second signal strength value is similar to the first signal strength value. Accordingly, when the second signal strength value is the closest to the first signal strength value, the first electronic device 10 sends the access information IA generated by using the second network name ID2 to the second electronic device 12, so that the second electronic device 12 establishes the second wireless connection C2 in the second frequency band B2 with the network access device 20 (i.e., operation S204). Also, when the second signal strength value is not the closet to the first signal strength value, it means that the second beacon signal is not outputted by the network access device 20, which results in the execution of operations S205-S207.

Furthermore, the signal strength value of the beacon signal may be affected by the transmission distance or the obstacle on the transmission path. That is to say, the second beacon signal is possibly outputted by another network access device, even though the second signal strength value is the closest to the first signal strength value. Thus, the first electronic device 10 has to further check whether both the first electronic device 10 and the second electronic device 12 connect to the same network access device 20. In some further embodiments, the first electronic device 10 determines if the second electronic device 12 communicates with the first electronic device 10 through the network access device 20. When the second electronic device 12 cannot communicate with the first electronic device 10 through the network access device 20, it means that the second electronic device 12 connects to the another network access device different from the network access device 20, which results in the execution of operations S205-S207. When the second electronic device 12 communicates with the first electronic device 10 through the network access device 20, it means that the first electronic device 10 and the second electronic device 12 connect to the same network access device 20. In this case, the second wireless connection C2 in the second frequency band B2 between the second electronic device 12 and the network access device 20 is maintained.

In some further embodiments of FIG. 4, the first electronic device 10 calculates a first data throughput of the first wireless connection C1, and receives a second data throughput of the second wireless connection C2 calculated by the second electronic device 12. Then, the first electronic device 10 determines that the second data throughput is greater than the first data throughput. In this case, the first wireless connection C1 is switched from being in the first frequency band B1 to being in the second frequency band B2, and the second wireless connection C2 is switched from being in the second frequency band B2 to being in the first frequency band B1.

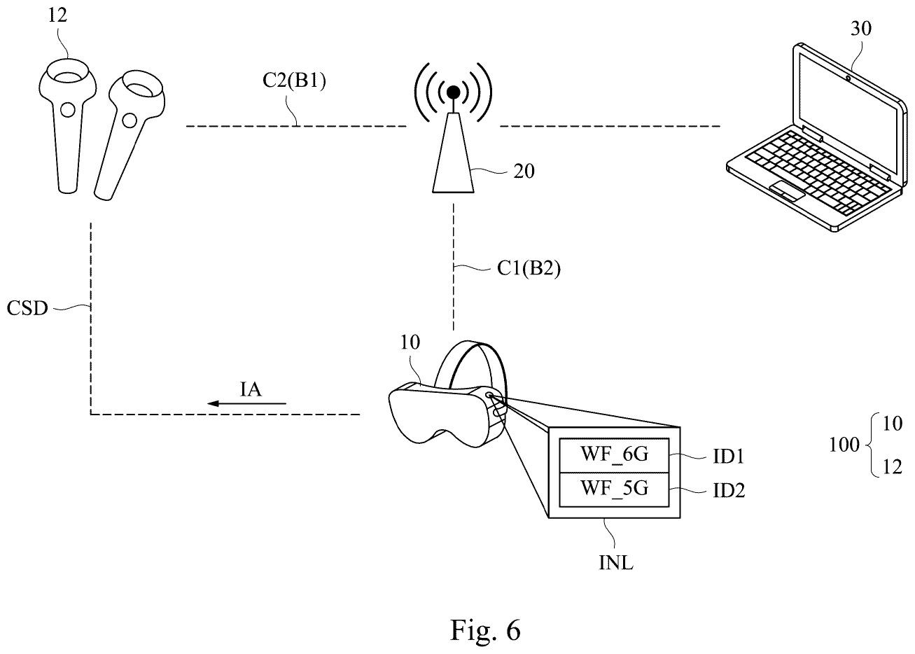

Referring to FIG. 6, FIG. 6 is a schematic diagram of a scenario of the multi-device system 100 in accordance with some embodiments of the present disclosure. In some embodiments, the first electronic device 10 can use at least the second network name ID2 and the second authentication information, which are described in operation S203, to re-establish the first wireless connection C1 in the second frequency band B2 with the network access device 20. Also, the electronic device 10 can transmit at least the first network name ID1 and the first authentication information, which are described in operation S202, as the access information IA to the second electronic device 12 through the short distance wireless connection CSD. Accordingly, the second electronic device 12 can re-establish the second wireless connection C2 in the first frequency band B1 with the network access device 20.

As can be seen from the above embodiments, by monitoring multiple data throughputs of multiple wireless connections among multiple electronic devices of the multi-device system 100 and the network access device 20, the multi-device system 100 can arrange the wireless connections to be in appropriate frequency bands, respectively, when the data throughputs of the wireless connections are changed. In sum, the multi-device system 100 and the wireless connection method 200 of the present disclosure has the advantage of optimizing the transmission throughputs of system.

The disclosed methods, may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for practicing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for practicing the disclosed methods. When implemented on a general-purpose processor, the program code combines with the at least one processor to provide a unique apparatus that operates analogously to application specific logic circuits.

Although the present disclosure has been described in considerable detail with reference to certain embodiments thereof, other embodiments are possible. Therefore, the spirit and scope of the appended claims should not be limited to the description of the embodiments contained herein. It will be apparent to those skilled in the art that various modifications and variations can be made to the structure of the present disclosure without departing from the scope or spirit of the invention. In view of the foregoing, it is intended that the present invention cover modifications and variations of this invention provided they fall within the scope of the following claims.

What is claimed is:

1. A wireless connection method applicable to a multi-device system, wherein the multi-device system comprises a first electronic device and a second electronic device, and the wireless connection method comprises:
by the first electronic device, determining if a network access device is available for a single-band communication or a multi-band communication;
by the first electronic device, establishing a first wireless connection in a first frequency band with the network access device; and
when the network access device is available for the multi-band communication, by the second electronic device, establishing a second wireless connection in a second frequency band with the network access device, wherein the first frequency band is larger than the second frequency band in a transmission bandwidth.

2. The wireless connection method of claim 1, wherein the first wireless connection and the second wireless connection are similar in network name, the first frequency band is corresponding to a first SSID (Service Set Identifier), the second frequency band is corresponding to a second SSID, and the first SSID has the same prefix as the second SSID.

3. The wireless connection method of claim 1, wherein determining if the network access device is available for the single-band communication or the multi-band communication comprises:
by the first electronic device, performing a network scanning, to record available network information provided by the network access device; and
when the available network information comprises a first network name corresponding to the first frequency band, by the first electronic device, determining if there is a second network name, which is corresponding to the second frequency band and has the same prefix as the first network name, in the available network information,
wherein the network access device is available for the multi-band communication when there is the second network name in the available network information, and is available for the single-band communication when there is no the second network name in the available network information.

4. The wireless connection method of claim 3, wherein when there is the second network name in the available network information, the wireless connection method further comprises:
by the first electronic device, sending the second network name and an access password to the second electronic device through a short distance wireless connection established between the first electronic device and the second electronic device, wherein the first electronic device is configured to use the access password to establish the first wireless connection.

5. The wireless connection method of claim 1, wherein the first frequency band is corresponding to a first network name indicated by a first beacon signal outputted by the network access device, and the wireless connection method further comprises:
by the first electronic device, receiving a second beacon signal, wherein the second beacon signal indicates a second network name; and
by the first electronic device, determining if the second network name has the same prefix as the first network name, wherein when the second network name has the same prefix as the first network name, the second network name is selected to generate access information configured to be provided to the second electronic device.

6. The wireless connection method of claim 5, wherein the first beacon signal is corresponding to a first signal strength value, and the wireless connection method further comprises:
by the first electronic device, determining if a second signal strength value of the second beacon signal is the closest to the first signal strength value; and
when the second signal strength value is the closest to the first signal strength value, by the first electronic device, sending the access information to the second electronic device.

7. The wireless connection method of claim 6, further comprising:
by the first electronic device, determining if the second electronic device communicates with the first electronic device through the network access device, wherein when the second electronic device communicates with the first electronic device through the network access device, the second wireless connection in the second frequency band between the second electronic device and the network access device is maintained.

8. The wireless connection method of claim 1, wherein when the network access device is available for the single-band communication, the wireless connection method further comprises:
by the first electronic device, sending access information corresponding to the first frequency band to the second electronic device through a short distance wireless connection established between the first electronic device and the second electronic device; and
by the second electronic device, establishing the second wireless connection in the first frequency band with the network access device according to the access information.

9. The wireless connection method of claim 1, further comprising:
by the first electronic device, calculating a first data throughput of the first wireless connection, and receiving a second data throughput of the second wireless connection calculated by the second electronic device.

10. The wireless connection method of claim 9, wherein when the second data throughput is greater than the first data throughput, the wireless connection method further comprises:
by the first electronic device, establishing the first wireless connection in the second frequency band with the network access device; and
by the second electronic device, establishing the second wireless connection in the first frequency band with the network access device.

11. A multi-device system, comprising:
a first electronic device, configured to determine if a network access device is available for a single-band communication or a multi-band communication, and configured to establish a first wireless connection in a first frequency band with the network access device; and
a second electronic device, configured to establish a second wireless connection in a second frequency band with the network access device when the network access device is available for the multi-band communication,
wherein the first frequency band is larger than the second frequency band in a transmission bandwidth.

12. The multi-device system of claim 11, wherein the first electronic device is configured to perform a network scanning, to record available network information provided by the network access device, and is configured to, when the available network information comprises a first network name corresponding to the first frequency band, determine if there is a second network name, which is corresponding to the second frequency band and has the same prefix as the first network name, in the available network information,
wherein the network access device is available for the multi-band communication when there is the second network name in the available network information, and is available for the single-band communication when there is no the second network name in the available network information.

13. The multi-device system of claim 12, wherein when there is the second network name in the available network information, the first electronic device is further configured to send the second network name and an access password to the second electronic device through a short distance wireless connection established between the first electronic device and the second electronic device, wherein the first electronic device is configured to use the access password to establish the first wireless connection.

14. The multi-device system of claim 11, wherein the first frequency band is corresponding to a first network name indicated by a first beacon signal outputted by the network access device,
wherein the first electronic device is further configured to receive a second beacon signal indicating a second network name, and is configured to determine if the second network name has the same prefix as the first network name,
wherein when the second network name has the same prefix as the first network name, the second network name is selected to generate access information configured to be provided to the second electronic device.

15. The multi-device system of claim 14, wherein the first beacon signal is corresponding to a first signal strength value,
wherein the first electronic device is further configured to determine if a second signal strength value of the second beacon signal is the closest to the first signal strength value, and is configured to send the access information to the second electronic device when the second signal strength value is the closest to the first signal strength value.

16. The multi-device system of claim 15, wherein the first electronic device is further configured to determine if the second electronic device communicates with the first electronic device through the network access device,
wherein when the second electronic device communicates with the first electronic device through the network access device, the second wireless connection in the second frequency band between the second electronic device and the network access device is maintained.

17. The multi-device system of claim 11, wherein when the network access device is available for the single-band communication, the first electronic device is further configured to send access information corresponding to the first frequency band to the second electronic device through a short distance wireless connection established between the first electronic device and the second electronic device, and the second electronic device is further configured to establish the second wireless connection in the first frequency band with the network access device according to the access information.

18. The multi-device system of claim 11, wherein the first electronic device is further configured to calculate a first data throughput of the first wireless connection, and is configured to receive a second data throughput of the second wireless connection calculated by the second electronic device.

19. The multi-device system of claim 18, wherein when the second data throughput is greater than the first data throughput, the first electronic device is further configured to establish the first wireless connection in the second frequency band with the network access device, and the second electronic device is further configured to establish the second wireless connection in the first frequency band with the network access device.

20. A non-transitory computer readable storage medium with a computer program to execute a wireless connection method applicable to a multi-device system, wherein the multi-device system comprises a first electronic device and a second electronic device, and the wireless connection method comprises:
by the first electronic device, determining if a network access device is available for a single-band communication or a multi-band communication;
by the first electronic device, establishing a first wireless connection in a first frequency band with the network access device; and
when the network access device is available for the multi-band communication, by the second electronic device, establishing a second wireless connection in a second frequency band with the network access device, wherein the first frequency band is larger than the second frequency band in a transmission bandwidth.
